(19) United States
(12) Patent Application Publication
(10) Pub. No.: US 2026/0098561 A1
(43) Pub. Date: Apr. 9, 2026

(54) SELF-DRILLING AND THREAD-FORMING SCREW MADE OF STAINLESS STEEL AND METHOD FOR ITS MANUFACTURE

(71) Applicant: SFS Group International AG, Heerbrugg (CH)

(72) Inventors: Markus ANDERSAG, Lustenau (AT); Tim FEDERER, Heerbrugg (CH)

(73) Assignee: SFS Group International AG, Heerbrugg (CH)

(21) Appl. No.: 19/317,401

(22) Filed: Sep. 3, 2025

(30) Foreign Application Priority Data
Oct. 3, 2024 (EP) 24204555.7

(51) Int. Cl. F16B 25/00

(52) U.S. Cl. CPC F16B 25/0047; F16B 25/0084

(57) ABSTRACT

A self-drilling, thread-forming screw made of stainless-steel has the following functional sections that merge into and/or are adjacent to one another: A screw tip, a truncated cone having a terminating dome, a cylindrical shank threaded at least in sections, and a head. A thread-like relief structure having longitudinally extended, arcuate ribs is arranged on the jacket of the truncated cone. These ribs, viewed in the longitudinal direction, are arranged one behind the other but spaced apart and follow a virtual helical curve. The screw is entirely manufactured of stainless-steel without post-manufacturing heat treatment to improve the material hardness by cold forming the screw head by upsetting. The screw tip is formed with the special thread-like relief structure consisting of the arcuate ribs, with this shape being achieved by a pinching movement transverse to the longitudinal axis between two opposing tool jaws. Protruding material is sheared off during subsequent thread rolling.

### CROSS-REFERENCE TO RELATED APPLICATIONS

This application claims priority from European Patent Application No. 24204555.7, filed Oct. 3, 2024, which is incorporated herein by reference as if fully set forth.

### TECHNICAL FIELD

The present invention relates to fasteners, in particular stainless steel screws, which are self-drilling or self-tapping. A method for manufacturing them is also described.

### BACKGROUND

Steel is usually defined as an iron-carbon alloy with a carbon content of no more than 2%. Carbon steel or unalloyed steel refers to variants that contain only minor impurities or no deliberately added alloying elements such as chromium, nickel, copper, manganese, or silicon. Stainless steels, often referred to as high-grade steels or, more precisely, low-corrosion steels, are characterized by an alloy content of >10% chromium and less than 1.2% carbon.

Due to the incorporation of carbon into the matrix of the steel lattice, carbon steel can generally be hardened better than low-corrosion steels. This hardening is usually achieved by hardening processes (heat treatment, case hardening such as carbonitriding) or cold forming processes.

Among the low-corrosion steels, the most common are those with chromium and nickel alloy components, such as steel grades 1.4301 (V2A or A2) and 1.4401 (V4A or A4). Standards exist for these steels with specified compositions, so that grades with comparable properties can be obtained from different sources. These steels are also referred to as austenitic because the alloying elements Ni, C, Mn, and N stabilize the austenite phase in the steel during production.

Duplex steel is a steel with a two-phase structure consisting of a ferrite matrix with islands of austenite. Compared to purely austenitic steels, duplex steel has a lower nickel content, which means that not all of the structure becomes austenitic at room temperature. Examples of this are grades 1.4462 and 1.4362.

The manufacture of fasteners and screws made purely from stainless steels is well known; however, the penetration capacity of steel with corresponding (self-)drilling screws or hole-and thread-forming screws is limited. There is therefore a need for fasteners made of corrosion-resistant steel, in particular screws or self-drilling screws and thread-forming self-drilling screws, which can be manufactured entirely from a corrosion-resistant steel grade and can still penetrate steel sheets with a thickness of >1.5 mm without pre-drilling.

### DESCRIPTION OF THE PRIOR ART

The disclosure document DE 29 29 179 describes a corrosion-resistant, self-drilling and thread-forming screw made of a stainless austenitic steel material (according to US standard series 300). The method steps involve forming a head by upsetting at the end of a wire section of the aforementioned material and then, at the opposite end, forming a drill tip by means of a pinching process with a defined maximum closing speed of the pinching jaws. This transforms the austenitic structure of the drill tip into a martensitic structure. The document also recommends cooling the press blank to temperatures below 0° C., e.g. using dry ice.

EP 2 080 572 describes the production of a high-strength fastener made of austenitic steel of the 300 series (according to US standard) by reducing the diameter of a shank blank by 15% in a first step by cold forming. The head and tip are then also produced by cold forming. The thread is produced on the shank by a rolling process. It is also proposed to improve the rust resistance of the cold-formed fastener by post-treatment or coating.

The documents DE 2 103 053 and U.S. Pat. No. 3,683,436 describe the manufacture of a drill screw with a pinched drill tip. The wire blank is reduced in diameter at one end by extrusion and then brought into its final shape by pinching.

The production of threads on the shank and/or tip of a screw by rolling or rolling is common prior art.

These and other documents in the prior art have in common that the design of the tips is decisive for the usability of the screws. Very often, known tip shapes are combined with modified manufacturing methods.

### DEFINITIONS

In this document, a fastener is defined as a mechanical component that can be used to permanently connect two components (either detachably or non-detachably). A screw is specifically defined as a fastener that has an essentially longitudinally extended shank with a cylindrical or cylinder-like cross-section. At one longitudinal end of the shank there is a force application point, which may be designed as a head with force application surfaces. The tip of the screw is located at the opposite end of the shank. The tip refers to the longitudinal section of the screw where the cylindrical section or shank ends and the screw tapers to its end.

The shank is threaded in at least one section; it can be single-start or multi-start with a constant or variable pitch. The tip can generally be designed as a drill tip with cutting edges, as a blunt conical, threadless displacement tip, or as a pointed conical, self-drilling, and thread-cutting tip (thread tip). Depending on the application, the thread can extend from the shank to the cone or to the tip of the screw.

Originally, a drill screw was simply a screw with a drill tip whose cutting edges cut a hole in the components to be joined when inserted. Today, self-drilling screws are all screws that do not require pre-drilling before insertion. Tip shapes of screws that can penetrate the base material without producing abrasive chips are characterized as chip-free. Thread-forming means that a screw creates its own retaining thread during the setting process. Self-drilling screws are always thread-forming, but thread-forming screws are not necessarily self-drilling.

The term “cone” refers to the familiar geometric shape that is created when all points on the boundary line of a flat surface are connected to a point in space. If the flat surface (=base) is a circular disc, the shape is called a circular cone, and the point in space is the apex of the circular cone. If the perpendicular from the apex to the plane passes exactly through the center of the circular disc/base, this is referred to as a straight circular cone. In this case, the perpendicular also forms the central axis of rotation of the circular cone. The outer surface of a circular cone thus consists of the base and the lateral surface (jacket).

If a smaller cone is cut off parallel to the base, a truncated cone is formed. The resulting intersection is called the top surface; the surface of the truncated cone therefore consists of the base, the top surface, and the lateral surface. The central axis or axis of rotation thus runs perpendicular through the center of the circle of the top surface and base surface. In this disclosure, a truncated cone half is understood to be the body that is created when a truncated cone is halved along the central axis so that a plane of intersection is created.

When the shape of an object is described using the above terms in this disclosure, it is clear to the person skilled in the art that a technical product will never have this geometric shape in the mathematically perfect sense. Depending on the production process, a product will be similar to the geometric shape within the limits of manufacturing accuracy and tool design. Specifically, a shape described mathematically as a truncated cone is not technically ideal or perfectly feasible in mass production. However, if reference is made to a truncated cone within the scope of the description, shapes that deviate from the ideal but are fundamentally truncated cone-shaped are also included.

A thread is usually understood to be a longitudinally extended, continuous spiral-like elevation on a (usually) cylindrical surface. In the technical context of a screw or nut, this is referred to as a thread pitch. The thread thus forms a spiral or helix on the base body. Single-start threads consist of a single helix. Multi-start threads comprise several threads or spirals that are arranged so that they interlock in such a way that the threads run parallel to each other.

The cross-section of a thread is usually of triangular or trapezoidal design, but may deviate from these standard specifications. The elongated side surfaces of the thread are called flanks, and the upward-facing longitudinal edge of the thread is called the thread edge. It often has a sharp burr that facilitates cutting into the workpiece. The thread height is usually selected depending on the material of the workpiece so that the screw can be tightened with a manageable torque, provides a good hold, and does not break the material of the workpiece.

The entirety of the thread therefore forms a relief or relief structure on the lateral surface (and, if applicable, the tip) of a screw. In the present invention, the term “rib” is used figuratively to denote a section of a thread that is formed in relief on the surface of a screw, with the entirety of the ribs forming the relief structure.

In the prior art, both continuous and interrupted thread pitches are known. Furthermore, it is generally known to vary the shape or dimensions of the cross-section of a thread pitch in a screw type depending on the area of application. Single-start and multi-start threads are also known.

Screws are usually manufactured by cold forming processes. Cold forming processes include rolling, upsetting, drawing, and extrusion. Technically, cold forming is understood by those skilled in the art to mean plastic forming of metals below the recrystallization temperature, which is known to result in (desirable) cold hardening of the formed material. Pinch forming refers to a special type of cold forming in which, in the context of this disclosure, one longitudinal end of a (screw) blank is pressed into the desired shape (e.g., a drill tip) by two converging pinch jaws.

### SUMMARY

In the present invention, however, a new design of a tip for a screw of the present type is proposed.

The invention relates to a self-drilling, thread-forming screw made of stainless steel material. Stainless steel material refers in particular to steels with the material numbers 1.4301, 1.4551 or 1.4307 (V2A), or 1.4401, 1.4571 or 1.4404 (V4A) or 1.4462, 1.4362, 1.4410 or 1.4501 (Duplex).

The basic structure of such a screw comprises the following functional sections, which merge into one another or are adjacent to one another. At one end, there is a screw tip, which here comprises a truncated cone with a dome at the pointed end of the truncated cone. Unless specified otherwise, the term “dome” refers to a rounded end (within the limits of technical feasibility and manufacturability). The wide end of the truncated cone is connected to a substantially cylindrical shank, which is threaded at least in sections. This is followed by a head with a force application point. The type of force application is defined by the intended use and is selected by the relevant person skilled in the art based on the prior art.

With regard to the present invention, a thread-like relief structure consisting of longitudinally extended, arcuate ribs is arranged on the surface of the truncated cone. Ribs are described here as a special form of individual thread sections and fulfill at least the following criteria: They are (a) arranged in a straight line (direction of travel) when viewed in the longitudinal direction, but (b) spaced apart from each other and follow a virtual helical curve. The curve is referred to as “virtual helical” because its course is indicated by the “dashed”ribs, but is not continuous.

It has proven effective to arrange the arcuate ribs on the surface of each truncated cone half so that the rib-free areas are located or arranged in two transition strips. A truncated cone half is created by mentally halving a truncated cone along its central axis. The rib-free transition strips are thus offset by 180° on the lateral surface of the truncated cone, i.e. they are opposite each other on the surface. The transition strips extend on both sides of the dividing line or imaginary seam between the truncated cone halves. Their width (and thus the longitudinal distance between two ribs) is determined by the manufacturing process and the intended use of the screw. The shape of the transition strip can be trapezoidal or rectangular, following the tapered shape of the cone.

It is advantageous if the arcuate ribs have a lead-in or lead-out towards the transition strip. Lead-in or lead-out means that the height of the ribs decreases to zero relative to the surface of the cone.

The relief structure of the arcuate ribs can be continued from the truncated cone to the tip or taper off there. For certain applications, it may be advantageous to provide thread-like structures on the tip as well. The tip angle of the truncated cone is advantageously selected between 25° and 40°, preferably approx. 35°. The truncated cone is ideally designed so that its top surface has a diameter of 0.3 mm to 0.5 mm.

In the present invention, the cross-section of all ribs, with the exception of the entries and exits, is preferably dome-shaped, with a constant height relative to the surface of the truncated cone. The width of the ribs, with the exception of the entries and exits, is advantageously between 0.3 mm and 0.6 mm at the transition to the outer surface. The height of the ribs (with the exception of the entries and exits) is advantageously selected between 0.15 mm and 0.3 mm.

The pitch of the virtual helical curve on the truncated cone is preferably selected to be uniform and constant. It is also advantageous if the pitch of the virtual helical curve on the truncated cone corresponds to the pitch of the thread on the shank.

In a further embodiment, the ribs on the truncated cone are arranged so that the angle between the entry and exit, relative to the center axis of the truncated cone, is between 100° and 170°. Since each rib is arranged on one half of the truncated cone, this specification means that the angle difference to 180° will be eliminated on the transition strips. The design of the rib length will therefore influence the width of the transition strips or, depending on the design, vice versa.

Depending on the application of the screw, two or more thread-like relief structures with separate, virtual helical curves can be created on the jacket of the truncated cone in the form of a double or multi-start thread.

It has been shown that the dome that closes the truncated cone at the screw tip advantageously has a ball segment-like shape. The radius of the dome can be 0.3 to 0.5 mm, for example.

In another useful variant, the truncated cone can be irregularly shaped with a circular base and an elliptical top surface. Between the top surface and the base surface, the top surface ellipse merges into the circular surface of the base surface. However, the term “irregular” also includes a design in which a circular base surface merges into an elliptical shape and then back into a circular surface at the top surface.

In all of the above variants of regular or irregular truncated cones, however, the plane of intersection between the two halves of the truncated cone is always chosen so that it encloses the short semi-axes of the ellipse. The specifications and options already mentioned apply to the arrangement of the ribs. The tip adjacent to the top surface takes on the shape of the top surface and is also rounded off.

The ribs should preferably have a cross-section that essentially (within the limits of manufacturability) forms a semicircle, a circle segment or part of an ellipse.

The screw described above in terms of its structure can be manufactured entirely from stainless steel using a cold forming process without the need for a heat treatment process to improve the material hardness after the manufacturing process. This can be achieved in the following steps:
A: Providing a shank-shaped blank as a wire section made of a stainless steel material;
B: Upsetting a screw head by cold forming at a first longitudinal end of the blank;
C: Forming a screw tip at the second longitudinal end of the blank, wherein the screw tip comprises a truncated cone with a terminating dome and has a thread-like relief structure of longitudinally extended, arcuate ribs on the truncated cone. This shape can be achieved by a pinching movement between two opposite tool jaws transverse to the longitudinal axis (of the screw).

Subsequently, in step D, any protruding material tabs remaining on the screw tip (from the pinching process) are sheared off on the shank during a subsequent thread rolling process.

The method can be refined by preforming a substantially conical tip at the second longitudinal end of the blank before step C. This can be carried out by a pinching movement between two opposite tool jaws transverse to the longitudinal axis. It is advantageous to cool the blank between the preforming described above and process step C. Cooling can be carried out actively with fluids (dipping, wetting, gas flow) or passively by allowing the blank to cool.

Stainless steels of the standards 1.4301, 1.4551 or 1.4307 (V2A), or 1.4401, 1.4571 or 1.4404 (V4A) or 1.4462, 1.4362, 1.4410 or 1.4501 (duplex) are preferred for this method.

### BRIEF DESCRIPTION OF THE DRAWINGS

The invention will now be explained with reference to the accompanying drawings, in which:

FIG. 1 shows a side view of an exemplary screw;

FIG. 2 shows basic geometric shapes and the association with corresponding terms used in this description;

FIG. 3 shows a perspective oblique view from above of a truncated cone 120, which is divided by a plane of intersection 125 into two equally sized conical halves 121, with the front half being illustrated in detail, to illustrate a thread formation;

FIGS. 4A-4C show three examples of rib cross-sections; and

FIG. 5 shows a vertical top view of the top surface and the adjacent lateral surface of a variant of an irregular cone showing an exemplary two-part thread.

### DETAILED DESCRIPTION

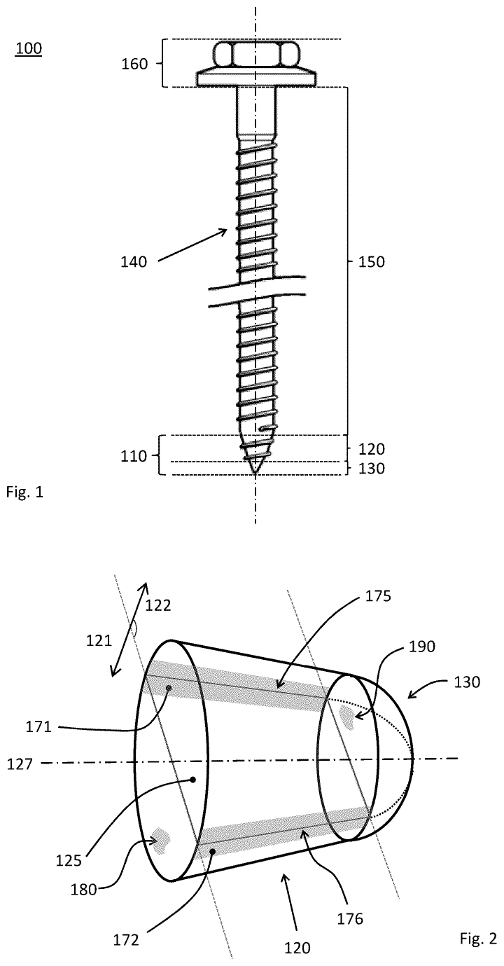

FIG. 1 shows, in side view, an example of a screw 100 with a structure (in the drawing from top to bottom) having a head 160, followed by a substantially cylindrical shank 150 with a thread 140. The shank merges into a screw tip 110, which can be divided into a tapered truncated cone 120 with a dome 130 at the end.

FIG. 2 serves in particular to explain the basic geometric shapes and corresponding terms as used in this description. The figure shows a truncated cone 120 with a dome 130 connected to the top surface 190 of the truncated cone 120. The radius of the dome is shown here as an example; other technically feasible dome shapes may be used. 127 denotes the central axis of truncated cone 120 and dome 130; it is also the axis of rotational symmetry. A plane of intersection 125 divides the truncated cone 120 and the dome 130 into two halves of equal size. The base surface 180 and top surface 190 of the truncated cone 120 intersect the plane 125 at right angles. The center axis 127 lies in the plane 125. The two halves of the truncated cone are designated 121 and 122; they therefore lie (in the drawing) above and below the plane 125. Where the plane 125 intersects the lateral surface of the truncated cone 120, there are two dividing lines 175, 176 between the two halves of the truncated cone 121 and 122. The so-called transition strips adjacent to these dividing lines 175 and 176 are marked with 171 and 172 in the drawing. They mark a boundary area that lies partly in the lateral surface of the first truncated cone half 121 and partly in the lateral surface of the second truncated cone half 122. The logic of the geometry dictates that there are therefore two transition strips 171, 172 per truncated cone 120.

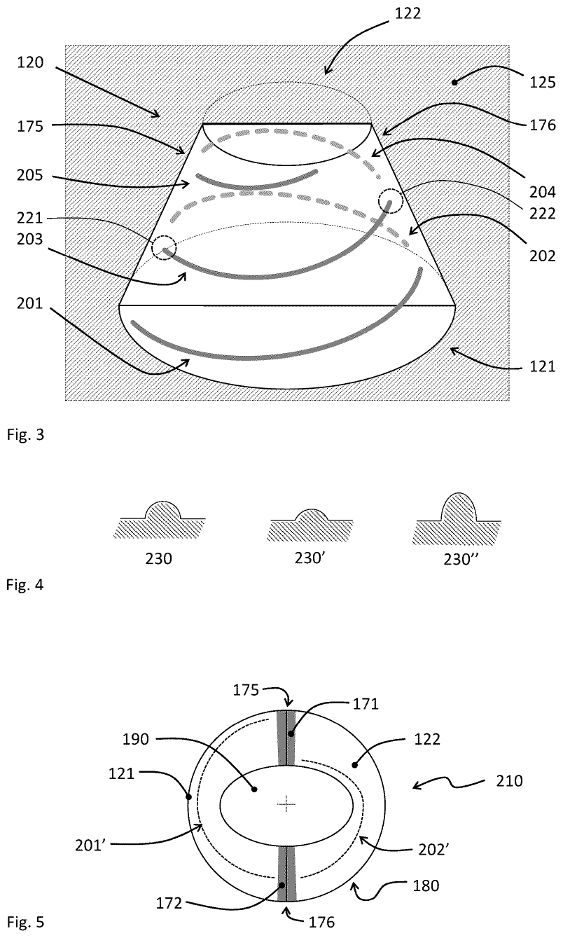

FIG. 3 shows a perspective oblique view from above of a truncated cone 120, which is divided by a plane of intersection 125 into two equally sized conical halves 121 (front half in the drawing) and 122 (rear half). A thread extends on the lateral surface of the truncated cone 120, starting from the lower base surface in the direction of the top surface. According to the invention, the thread is formed from individual sections or ribs that lie on a common virtual helical curve. In FIG. 3, the sequence of the sections/ribs on the virtual helical curve is therefore 201-202-203-204-205. The pattern or structure of these sections/ribs form the relief or relief structure arranged on the surface of the truncated cone. The odd-numbered thread sections are located in the front half of the truncated cone 121, and the even-numbered ones in the rear half of the truncated cone 122. The areas where no thread is formed correspond to the transition areas 171, 172 in FIG. 2 and are not marked here for clarity. However, the dividing lines 175, 176 are shown. The entry and exit of a section or a rib are marked with 221 and 222, respectively, as an example for rib 203. The number of thread sections will vary depending on the dimensions of the screw and the pitch of the thread. Depending on the design, double or multiple threads are also possible.

FIGS. 4A-4C show three examples of how the ribs 201 . . . 205 can be designed in cross-section. Cross-section 230 can be achieved with a ball milling cutter in the tool for the production of the pointed design shown. In this case, the dome-shaped cross-section would be created by a semicircular groove in the tool. 230′ can be achieved if the ball milling cutter only penetrates shallowly. 230″ could be produced with an elliptical milling cutter in the tool mold. The illustrations in FIGS. 4A-4C are schematic and exemplary; other variants are conceivable—the feasibility is determined not least by the formability of the metal in the tool and the tool geometry, which must be determined by trials.

FIG. 5 shows a vertical top view of the top surface 190 and the adjacent lateral surface of a variant of an irregular cone 210. In the embodiment shown, the base surface 180 is circular, but the top surface 220 is elliptical. This design offers advantages if the transition strips 171, 172 between the two truncated cone halves 121 and 122 are arranged with the dividing lines 175, 176 in such a way that they are intersected by a plane whose orientation is defined by the short semi-axes of the (here elliptical) top surface 190. For orientation purposes, only a two-part thread 201′, 202′ is schematically indicated by a dashed line in FIG. 5.

1. A self-drilling, thread-forming screw (100) made of stainless steel material, comprising the following functional sections that at least one of merge into or are adjacent to one another:
a screw tip (110) comprising a truncated cone (120) with a terminating dome (130);
a substantially cylindrical shank (150) bearing a thread (140) at least in sections; and
a head (160) with a force application point;
a thread-shaped relief structure consisting of longitudinally extended, arcuate ribs (201, . . . 205) arranged on a lateral surface of the truncated cone (120), and the ribs (201, . . . 205)
a) are arranged one behind the other when viewed in a longitudinal direction,
b) are present spaced apart from each other, and
c) follow a virtual helical curve.

2. The screw (100) according to claim 1, wherein the truncated cone includes two truncated cone halves, the arcuate ribs (201, . . . 205) on the lateral surface of each of the truncated cone halves (121, 122) are arranged such that rib-free areas are present in two transition strips (170, 172) which
a) are arranged at an angle of 180° on the lateral surface of the truncated cone (120), and
b) extend on both sides of a dividing line between the truncated cone halves (121, 122).

3. The screw (100) according to claim 2, wherein the arcuate ribs (201, . . . 205) each have an entry or exit (221, 222) in a direction of the transition strip (171, 172), and a height of the ribs decreases to zero relative to the lateral surface of the truncated cone.

4. The screw (100) according to claim 3, wherein the thread-shaped relief structure of the arcuate ribs (201, . . . 205) is continued or tapers off on the terminating dome (130).

5. The screw (100) according to claim 3, wherein a cross-section of all of the arcuate ribs (201, . . . 205), except for the entries and exits (221, 222) of the arcuate ribs, is dome-shaped with a constant height relative to the lateral surface of the truncated cone (120).

6. The screw (100) according to claim 1, wherein a pitch of the virtual helical curve on the truncated cone (120) is constant.

7. The screw (100) according to claim 6, wherein the pitch of the virtual helical curve on the truncated cone (120) corresponds to a pitch of the thread (120) on the shank (150).

8. The screw (100) according to claim 3, wherein a width of the arcuate ribs (201, . . . 205), except for the entries and exits (221, 222) at a transition to an outer surface of the truncated cone (120), is between 0.3 and 0.6 mm.

9. The screw (100) according to claim 3, wherein a height of the arcuate ribs (201, . . . 205), except for the entries and exits (221, 222), is between 0.15 and 0.3 mm relative to an outer surface of the truncated cone (120).

10. The screw (100) according to claim 3, wherein the ribs are arranged such that an angle between the entry and exit (221, 222), relative to a center axis (127) of the truncated cone (120), is between 100° and 170°.

11. The screw (100) according to claim 1, wherein there are two or more of the thread-shaped relief structures with separate, virtual helical curves applied to the lateral surface of the truncated cone (120) that are arranged as a double or multiple thread.

12. The screw (100) according to claim 1, wherein the terminating dome (130) has a shape approximating a ball segment, closing off the truncated cone (120).

13. The screw (100) according to claim 12, wherein a radius of the dome is 0.3 to 0.5 mm.

14. The screw (100) according to claim 1, wherein the truncated cone (120) is irregularly shaped, having
(a) a circular base surface (180) that transitions into an elliptical top surface (190) or
(b) a circular base surface (180) that transitions into an elliptical shape and back into a circular top surface (190); and
a plane of intersection (125) between two truncated cone halves that form the truncated cone (120) is selected such that the plane of intersection encloses short semi-axes of an ellipse.

15. The screw (100) according to claim 5, wherein the cross-section of the ribs (201, . . . 205) essentially forms a semicircle, a circular segment, or part of an ellipse.

16. A method for manufacturing a screw (100) according to claim 1, made entirely of stainless steel material, wherein the screw (100) does not undergo any heat treatment process downstream of the manufacturing process to improve a material hardness, the method comprising the following steps:
A. providing a shank-shaped blank as a wire section made of the stainless steel material;
B. upsetting the screw head (160) by cold forming at a first longitudinal end of the blank;
C. forming the screw tip (110) at a second longitudinal end of the blank, wherein the screw tip (110) comprises the truncated cone (120) with the terminating dome (130) and has the thread-shaped relief structure consisting of the longitudinally extended, arcuate ribs (201, . . . 205) on the truncated cone (120), wherein this shape is achieved by a pinching movement between two opposite tool jaws transverse to the longitudinal axis; and
D. shearing off protruding material tabs remaining on the screw tip (110) during a subsequent thread rolling process on the shank (150).

17. The method according to claim 16, further comprising, prior to step C, preforming a substantially conical tip at the second longitudinal end of the blank by the pinching movement between the two opposite tool jaws transverse to the longitudinal axis.

18. The method according to claim 17, further comprising cooling the blank between the preforming and method step C.

19. The method according to claim 16, wherein the stainless steel material is a stainless steel selected from standards 1.4301, 1.4551,1.4307 (V2A), 1.4401, 1.4571, 1.4404 (V4A), 1.4462, 1.4362, 1.4410, or 1.4501 (Duplex).
